(19) United States
(12) Patent Application Publication
(10) Pub. No.: US 2025/0305599 A1
(43) Pub. Date: Oct. 2, 2025

(54) COMPOSITE TUBE ASSEMBLIES AND METHOD OF MANUFACTURING

(71) Applicant: General Electric Company, Schenectady, NY (US)

(72) Inventors: Daniel Gene Dunn, Guilderland, NY (US); Jared Hogg Weaver, Clifton Park, NY (US); Scott Roger Finn, Montgomery, OH (US)

(21) Appl. No.: 18/619,685

(22) Filed: Mar. 28, 2024

(51) Int. Cl. F16L 9/14

(52) U.S. Cl. CPC F16L 9/14

(57) ABSTRACT

A composite tube assembly includes a first composite tube having a first tubular core and a first outer composite material. The first outer composite material is bonded to a first outer face of the first tubular core. The composite tube assembly further includes a second composite tube having a second tubular core and a second outer composite material. The second outer composite material is bonded to a second outer face of the second tubular core. The second composite tube is coupled to the first composite tube.

### FIELD

The present disclosure relates to composite tube assemblies having one or more composite tubes coupled together at a reinforced joint.

### BACKGROUND

Modern machinery such as airplanes, automobiles, marine, rockets, space vehicles or industrial equipment may be subject to extreme operating conditions that include high temperatures, high pressure, and high speeds. Reinforced ceramic matrix composites (“CMCs”) comprising fibers dispersed in continuous ceramic matrices of the same or a different composition are well suited for structural applications because of their toughness, thermal resistance, high-temperature strength, and chemical stability. Such composites typically have high strength-to-weight ratio and maintain this attribute over a broad range of temperatures that exceeds metallic alloys. This renders them attractive in applications in which weight is a concern and high temperature structural attributes highly constrain the design of components and systems, such as in aeronautical and space vehicle applications. Their stability at high temperatures renders CMCs very suitable in applications in which components are in contact with a high-temperature gas, such as in a gas turbine engine and re-entry conditions of space vehicles in terrestrial and non-terrestrial environments.

### BRIEF DESCRIPTION OF THE DRAWINGS

A full and enabling disclosure of the present disclosure, including the best mode thereof, directed to one of ordinary skill in the art, is set forth in the specification, which makes reference to the appended figures, in which:

FIG. 1 illustrates a cross-sectional view of a composite tube having a partially hollow tubular core in accordance with embodiments of the present disclosure;

FIG. 2 illustrates a cross-sectional view of a composite tube having a solid tubular core in accordance with embodiments of the present disclosure;

FIG. 3 illustrates a partially exploded, cross-sectional view of a composite tube assembly in accordance with embodiments of the present disclosure;

FIG. 4 illustrates the composite tube assembly shown in FIG. 3 assembled in accordance with embodiments of the present disclosure;

FIG. 5 illustrates a partially exploded, cross-sectional view of a composite tube assembly in accordance with embodiments of the present disclosure;

FIG. 6 illustrates the composite tube assembly shown in FIG. 5 assembled in accordance with embodiments of the present disclosure;

FIG. 7 illustrates a partially exploded, cross-sectional view of a tube assembly in accordance with embodiments of the present disclosure;

FIG. 8 illustrates the composite tube assembly shown in FIG. 7 assembled in accordance with embodiments of the present disclosure;

FIG. 9 illustrates a partially exploded, cross-sectional view of a composite tube assembly in accordance with embodiments of the present disclosure;

FIG. 10 illustrates the composite tube assembly shown in FIG. 9 assembled in accordance with embodiments of the present disclosure; and

FIG. 11 is a flowchart of an exemplary method of manufacturing a composite tube assembly in accordance with embodiments of the present disclosure.

### DETAILED DESCRIPTION

Reference will now be made in detail to present embodiments of the disclosure, one or more examples of which are illustrated in the accompanying drawings. The detailed description uses numerical and letter designations to refer to features in the drawings. Like or similar designations in the drawings and description have been used to refer to like or similar parts of the disclosure.

The word “exemplary” is used herein to mean “serving as an example, instance, or illustration.” Any implementation described herein as “exemplary” is not necessarily to be construed as preferred or advantageous over other implementations. Additionally, unless specifically identified otherwise, all embodiments described herein should be considered exemplary.

For purposes of the description hereinafter, the terms “upper”, “lower”, “right”, “left”, “vertical”, “horizontal”, “top”, “bottom”, “lateral”, “longitudinal”, and derivatives thereof shall relate to the embodiments as they are oriented in the drawing figures. However, it is to be understood that the embodiments may assume various alternative variations, except where expressly specified to the contrary. It is also to be understood that the specific devices illustrated in the attached drawings, and described in the following specification, are simply exemplary embodiments of the disclosure. Hence, specific dimensions and other physical characteristics related to the embodiments disclosed herein are not to be considered as limiting.

The term “radially” refers to the relative direction that is substantially perpendicular to an axial centerline of a particular component, the term “axially” refers to the relative direction that is substantially parallel and/or coaxially aligned to an axial centerline of a particular component and the term “circumferentially” refers to the relative direction that extends around the axial centerline of a particular component.

As used herein, the terms “first”, “second”, and “third” may be used interchangeably to distinguish one component from another and are not intended to signify location or importance of the individual components.

The singular forms “a”, “an”, and “the” include plural references unless the context clearly dictates otherwise.

The term “at least one of” in the context of, e.g., “at least one of A, B, and C” refers only A, only B, only C, or any combination of A, B, and C.

Here and throughout the specification and claims, range limitations are combined and interchanged, such ranges are identified and include all the sub-ranges contained therein unless context or language indicates otherwise. For example, all ranges disclosed herein are inclusive of the endpoints, and the endpoints are independently combinable with each other.

The term “turbomachine” or “turbomachinery” refers to a machine including one or more compressors, a heat generating section (e.g., a combustion section), and one or more turbines that together generate a torque output.

The term “gas turbine engine” refers to an engine having a turbomachine as all or a portion of its power source. Example gas turbine engines include turbofan engines, turboprop engines, turbojet engines, turboshaft engines, etc., as well as hybrid-electric versions of one or more of these engines.

Chemical elements are discussed in the present disclosure using their common chemical abbreviation, such as commonly found on a periodic table of elements. For example, hydrogen is represented by its common chemical abbreviation H; helium is represented by its common chemical abbreviation He; and so forth.

As used herein, ceramic matrix composite refers to a class of materials that include a reinforcing material (e.g., reinforcing fibers) surrounded by a ceramic matrix phase. Generally, the reinforcing fibers provide structural integrity to the ceramic matrix. Some examples of matrix materials of CMCs can include, but are not limited to, non-oxide silicon-based materials (e.g., silicon carbide, silicon nitride, or mixtures thereof), oxide ceramics (e.g., silicon oxycarbides, silicon oxynitrides, aluminum oxide (Al₂O₃), silicon dioxide (SiO₂), aluminosilicates, or mixtures thereof), or mixtures thereof. Optionally, ceramic particles (e.g., oxides of Si, Al, Zr, Y, and combinations thereof) and inorganic fillers (e.g., pyrophyllite, wollastonite, mica, talc, kyanite, and montmorillonite) may also be included within the CMC matrix.

Some examples of reinforcing fibers of CMCs can include, but are not limited to, non-oxide silicon-based materials (e.g., silicon carbide, silicon nitride, or mixtures thereof), non-oxide carbon-based materials (e.g., carbon, silicon carbide, zirconium carbide), oxide ceramics (e.g., silicon oxycarbides, silicon oxynitrides, aluminum oxide (Al₂O₃), silicon dioxide (SiO₂), aluminosilicates such as mullite, or mixtures thereof), or mixtures thereof.

Generally, particular CMCs may be referred to as their combination of type of fiber/type of matrix. For example, C/SiC for carbon-fiber-reinforced silicon carbide; SiC/SiC for silicon carbide-fiber-reinforced silicon carbide, SiC/SiN for silicon carbide fiber-reinforced silicon nitride; SiC/SiC—SiN for silicon carbide fiber-reinforced silicon carbide/silicon nitride matrix mixture, etc. In other examples, the CMCs may include a matrix and reinforcing fibers comprising oxide-based materials such as aluminum oxide (Al₂O₃), silicon dioxide (SiO₂), aluminosilicates, and mixtures thereof. Aluminosilicates can include crystalline materials such as mullite (3Al₂O₃ 2SiO₂), as well as glassy aluminosilicates.

In certain embodiments, the reinforcing fibers may be bundled or coated prior to inclusion within the matrix. For example, bundles of the fibers may be formed as a reinforced tape, such as a unidirectional reinforced tape. A plurality of the tapes may be laid up together to form a preform component. The bundles of fibers may be impregnated with a slurry composition prior to forming the preform or after formation of the preform. The preform may then undergo thermal processing, such as a cure or burn-out to yield a high char residue in the preform, and subsequent chemical processing, such as melt-infiltration with silicon, to arrive at a component formed of a CMC material having a desired chemical composition.

Such materials, along with certain monolithic ceramics (i.e., ceramic materials without a reinforcing material), are particularly suitable for higher temperature applications. Additionally, these ceramic materials are lightweight compared to superalloys, yet can still provide strength and durability to the component made therefrom. Therefore, such materials are currently being considered for many gas turbine, space vehicle structure, and propulsion components used in higher temperature sections, such as airfoils (e.g., turbines, and vanes), combustors, shrouds and other like components, nozzles, transition ducts, thermal protection systems, TPS, aerodynamic control surfaces and leading edges that would benefit from the lighter-weight and higher temperature capability these materials can offer.

As used herein, the term “additive manufacturing” refers generally to manufacturing technology in which components are manufactured in a layer-by-layer manner. An exemplary additive manufacturing machine may be configured to utilize any suitable additive manufacturing technology. The additive manufacturing machine may utilize an additive manufacturing technology that includes a powder bed fusion (PBF) technology, such as a direct metal laser melting (DMLM) technology, a selective laser melting (SLM) technology, a directed metal laser sintering (DMLS) technology, or a selective laser sintering (SLS) technology. In an exemplary PBF technology, thin layers of powder material are sequentially applied to a build plane and then selectively melted or fused to one another in a layer-by-layer manner to form one or more three-dimensional objects. Additively manufactured objects are generally monolithic in nature and may have a variety of integral sub-components.

Additionally or alternatively suitable additive manufacturing technologies may include, for example, Binder Jet technology, Fused Deposition Modeling (FDM) technology, Direct Energy Deposition (DED) technology, Laser Engineered Net Shaping (LENS) technology, Laser Net Shape Manufacturing (LNSM) technology, Direct Metal Deposition (DMD) technology, Digital Light Processing (DLP) technology, and other additive manufacturing technologies that utilize an energy beam or other energy source to solidify an additive manufacturing material such as a powder material. In fact, any suitable additive manufacturing modality may be utilized with the presently disclosed the subject matter.

Additive manufacturing technology may generally be described as fabrication of objects by building objects point-by-point, line-by-line, layer-by-layer, typically in a vertical direction. Other methods of fabrication are contemplated and within the scope of the present disclosure. For example, although the discussion herein refers to the addition of material to form successive layers, the presently disclosed subject matter may be practiced with any additive manufacturing technology or other manufacturing technology, including layer-additive processes, layer-subtractive processes, or hybrid processes.

The additive manufacturing processes described herein may be used for forming components using any suitable material. For example, the material may be metal, ceramic, polymer, epoxy, photopolymer resin, plastic, or any other suitable material that may be in solid, powder, material, wire, or any other suitable form, or combinations thereof. Additionally, or in the alternative, exemplary materials may include metals, ceramics, or binders, as well as combinations thereof. Exemplary ceramics may include ultra-high-temperature ceramics, or precursors for ultra-high-temperature ceramics, such as polymeric precursors. Each successive layer may be, for example, between about 10 μm and 200 μm, although the thickness may be determined based on any number of parameters and may be any suitable size.

As used herein, the term “build plane” refers to a plane defined by a surface upon which an energy beam impinges to selectively irradiate and thereby consolidate powder material during an additive manufacturing process. Generally, the surface of a powder bed defines the build plane. During irradiation of a respective layer of the powder bed, a previously irradiated portion of the respective layer may define a portion of the build plane. Prior to distributing powder material across a build module, a build plate that supports the powder bed generally defines the build plane.

As used herein, the term “consolidate” or “consolidating” refers to densification and solidification of powder material as a result of irradiating the powder material, including by way of melting, fusing, sintering, or the like.

Of particular interest in the field of CMCs is the joining of one CMC subcomponent, or preform, to another CMC or ceramic subcomponent to form a complete component structure. For instance, the joining of one CMC subcomponent to another may arise when the shape complexity of an overall complete structure may be too complex to lay-up as a single part. Another instance where joining of one CMC subcomponent to another may arise is when a large complete structure is difficult to lay-up as a single part, and multiple subcomponents, or preforms, are manufactured and joined to form the large complete structure. Fabrication of complex composite components may require complex tooling, and may involve forming fibers over small radii, both of which lead to challenges in manufacturability. Current procedures for bonding CMC subcomponents include, but are not limited to, diffusion bonding, reaction forming, melt infiltration, brazing, adhesives, or the like. Of particular concern in these CMC component structures that are formed of conjoined subcomponents is the separation, or failure, of the joint that is formed during the joining procedure, when under the influence of applied loads.

Thus, an improved joint and method of joining one CMC subcomponent, or preform, to another ceramic monolithic subcomponent or CMC subcomponent to form a complete structure, is desired and would be appreciated in the art.

The present disclosure is generally related to composite tube assemblies having one or more composite tubes joined together. A composite tube may include an unreinforced core (which may be additively manufactured having one or more hollow cells and one and/or more interlocking features) and one or more composite plies bonded to the core. While certain composite materials, such as CMCs, provide good toughness, high thermal insulation, high-temperature strength, and chemical stability, the raw material and processing techniques can become expensive. Current structures capable of withstanding extreme operation conditions may be bulky, expensive, or have short lifespans. Accordingly, a lighter, stronger, and more cost-effective structure would be welcomed in the art. Composite panels can provide for similar properties while reducing weight of the component, and notably, the amount of composite material used in the component.

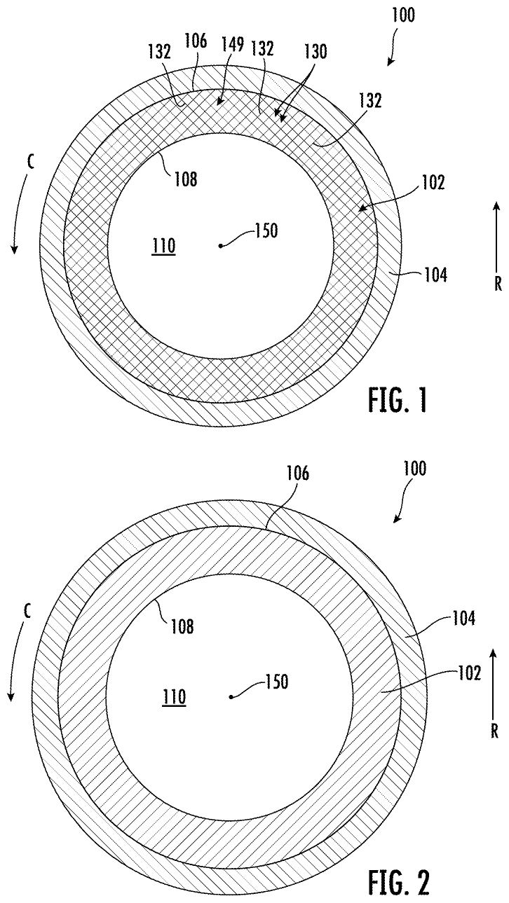

Referring now to the drawings, in which identical numerals indicate the same elements throughout the figures, FIGS. 1 and 2 each illustrate a cross-sectional view of a composite tube 100 having a tubular core 102 and a first outer composite material 104. The composite tube 100 and the composite tube assembly 200 discussed below with reference to FIGS. 3-10, may each define a cylindrical coordinate system having an axial direction A extending along an axial centerline 150, a radial direction R perpendicular to the axial centerline 150, and a circumferential direction C extending around the axial centerline 150. The first outer composite material 104 may annularly surround the tubular core 102 and may couple thereto.

The tubular core 102 may define a first face 106 (e.g., a radially outer surface) and a second face 108 (e.g., a radially inner surface). In many embodiments, the first outer composite material 104 may be bonded to the first face 106 of the tubular core 102. The second face 108 may define a passageway 110 (such as a fluid passageway), through which fluids, cables, or other components may extend. In some embodiments (not shown), the composite tube 100 may further comprise an inner composite material bonded to the second face 108 of the tubular core 102.

The first outer composite material 104 and the tubular core 102 can comprise a combination of different materials to facilitate structural and mechanical requirements for the composite tube 100. The first outer composite material 104 can comprise any composite material such as a ceramic matrix composite, described above. Composite materials generally comprise a fibrous reinforcement material embedded in matrix material. The reinforcement material serves as a load-bearing constituent of the composite material, while the matrix of a composite material serves to bind the fibers together and act as the medium by which an externally applied stress is transmitted and distributed to the fibers. Generally, CMCs are well suited for structural applications because of their toughness, thermal resistance, high-temperature strength, and chemical stability. Such composites may have high strength-to-weight ratio that renders them attractive in applications in which weight is a concern, such as in aeronautic applications. Further, their stability at high temperatures renders CMCs very suitable in applications in which components are in contact with a high-temperature gas, such as within a gas turbine engine.

Exemplary CMC materials may include silicon carbide (SiC), silicon, silica, carbon, or alumina matrix materials and combinations thereof. Ceramic fibers may be embedded within the matrix, such as oxidation stable reinforcing fibers including monofilaments like sapphire and silicon carbide (e.g., Textron's SCS-6), as well as rovings and yarn including silicon carbide (e.g., Nippon Carbon's NICALON®, Ube Industries' TYRANNO®, and Dow Corning's SYLRAMIC®), alumina silicates (e.g., 3M's Nextel 440 and 480), and chopped whiskers and fibers (e.g., 3M's Nextel 440 and SAFFIL®), and optionally ceramic particles (e.g., oxides of Si, Al, Zr, Y, and combinations thereof) and inorganic fillers (e.g., pyrophyllite, wollastonite, mica, talc, kyanite, and montmorillonite). For example, in certain embodiments, bundles of the fibers, which may include a ceramic refractory material coating, are formed as a reinforced tape, such as a unidirectional reinforced tape. A plurality of the tapes may be laid up together (e.g., as plies) to form a preform component. The bundles of fibers may be impregnated with a slurry composition prior to forming the preform (e.g., prepreg plies) or after formation of the preform. The preform may then undergo thermal processing, such as a cure or burn-out to yield a high char residue in the preform, and subsequent chemical processing, such as melt-infiltration with silicon, to arrive at a component formed of a CMC material having a desired chemical composition. In other embodiments, the CMC material may be formed as, e.g., a carbon fiber cloth rather than as a tape.

The tubular core 102 may comprise a different material compared to the first outer composite material 104. By way of non-limiting example, the tubular core 102 may be a material that is less dense than the material of the first outer composite material 104. However, even when the material of the tubular core 102 is different, it is compatible with the first outer composite material 104 to produce a sufficient bond between the components, including in extreme operating conditions such as high temperatures. In exemplary embodiments, the tubular core 102 may be an unreinforced material, i.e., free of fibers therein. In particular, using unreinforced material reduces a total amount of coated fibers, reducing overall material cost of the composite tube 100. The tubular core 102 may include silicon, silicon carbide, alumina, carbon, or aluminosilicates, or combinations thereof.

Referring specifically to FIG. 1, in some embodiments, the tubular core 102 comprises a plurality of hollow cells 130 defined by a plurality of lattice walls 132 extending between the inner face 108 and the outer face 106. As illustrated in FIG. 1, the plurality of lattice walls 132 of the plurality of hollow cells 130 define the shape, and more specifically, the cross-sectional geometry, of each of the plurality of hollow cells 130. That is, the plurality of lattice walls 132 create a partially closed structure to define a hollow interior 149 to form a cross-sectional geometry for each of the plurality of hollow cells 130. The cross-sectional geometry can comprise a variety of different shapes within each of the plurality of hollow cells 130. For example, as shown in the embodiment of FIG. 1, the cross-sectional geometry of each hollow cell 130 may be a square throughout the length of each hollow cell 130, including at respective ends of the hollow cell 130 (not shown). However, the cross-sectional geometry of the plurality of hollow cells 130 may be any one of a hexagon, circle, triangle, or others in non-limiting examples. In other embodiments, as shown in FIG. 2, the tubular core 102 may be solid. As used herein, “solid” may refer to a component or components that does not define any substantial cavities or voids.

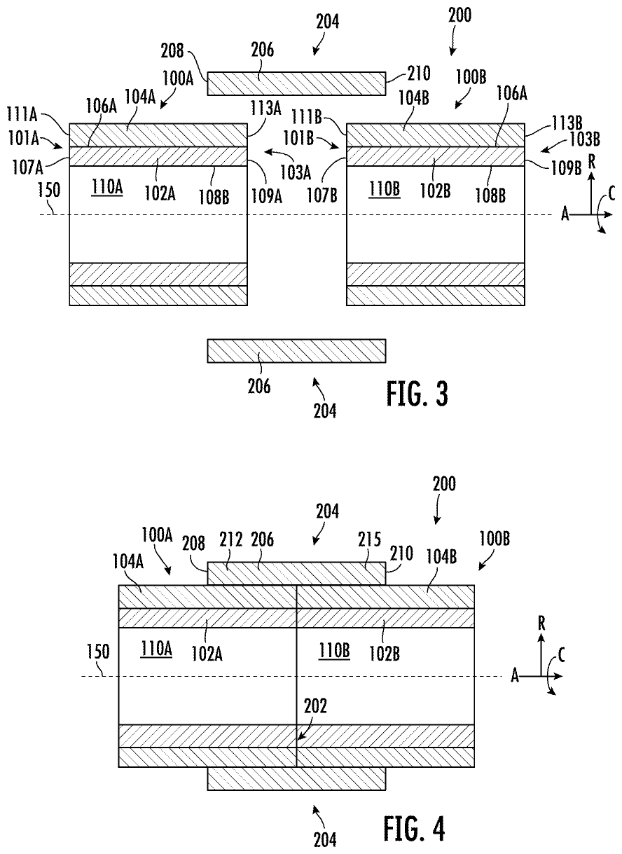

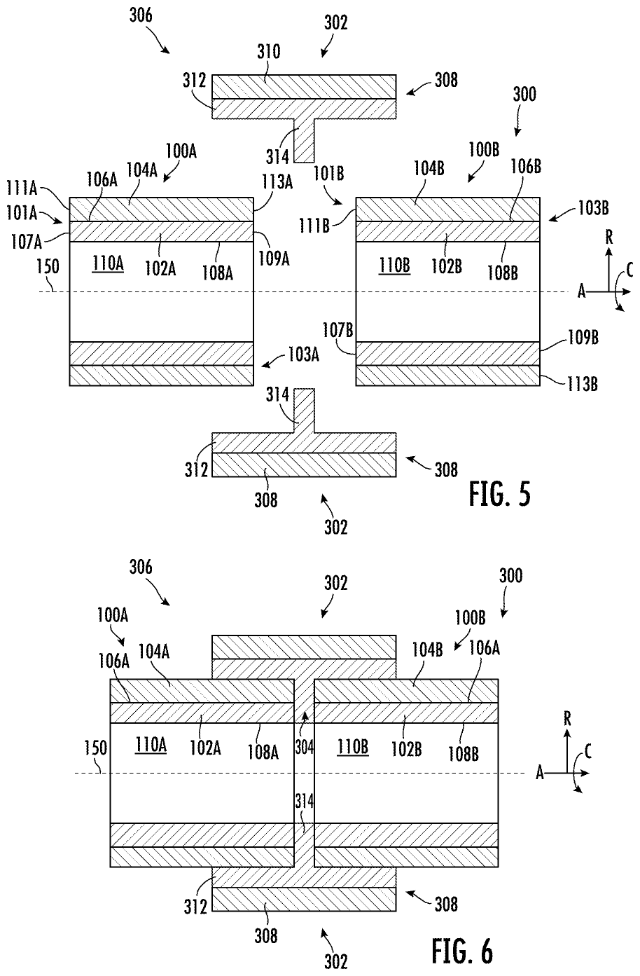

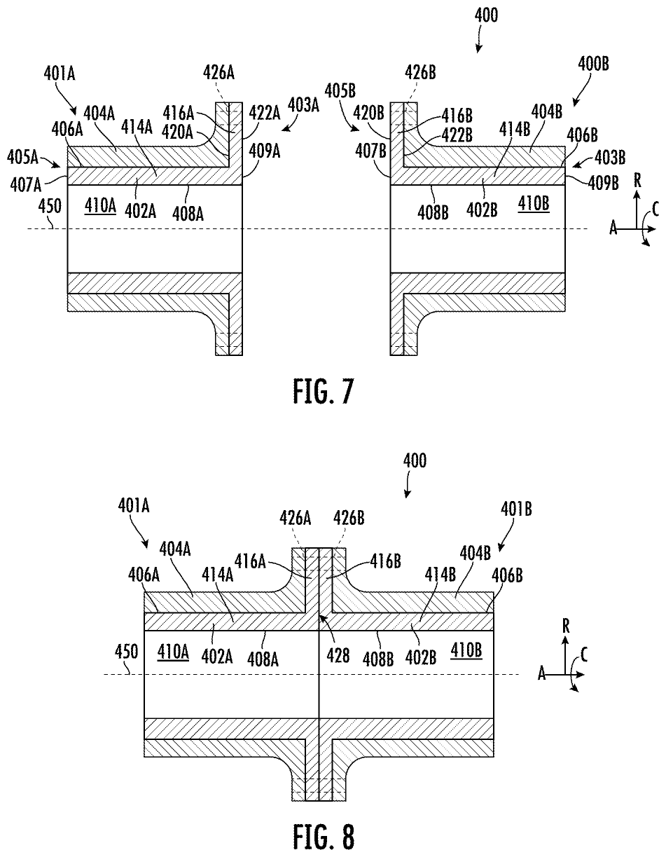

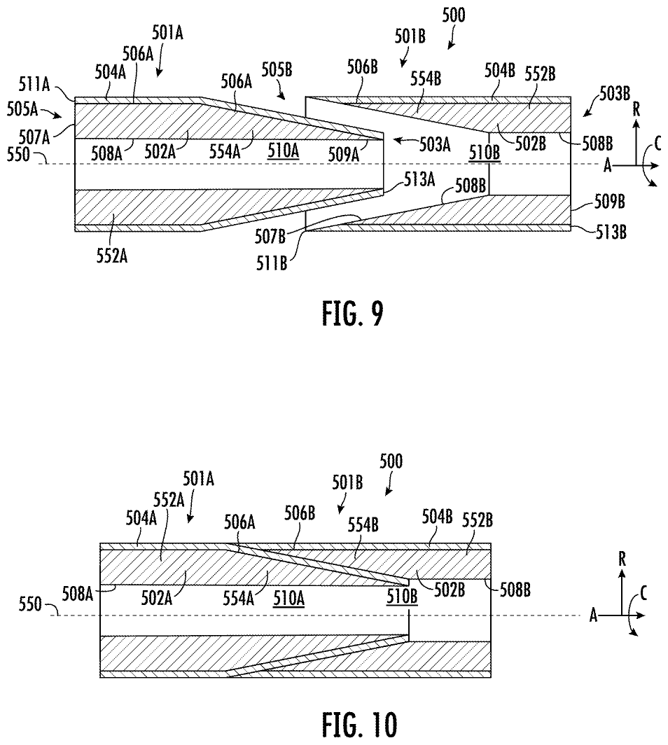

FIGS. 3 through 10 each illustrate embodiments of a composite tube assembly 200 according to the present disclosure. Particularly, FIGS. 3 and 4 illustrate a composite tube assembly 200 in accordance with a first embodiment of the present disclosure; FIGS. 5 and 6 illustrate a composite tube assembly 200 in accordance with a second embodiment of the present disclosure; FIGS. 7 and 8 illustrate a composite tube assembly 200 in accordance with a third embodiment of the present disclosure; and FIGS. 9 and 10 illustrate a composite tube assembly 200 in accordance with a fourth embodiment of the present disclosure.

As commonly shown for the composite tube assemblies of FIGS. 3 through 10, the composite tube assembly 200 may include a first composite tube 100A having a first tubular core 102A and a first outer composite material 104A. The first tubular core 102A may define a first outer face 106A (e.g., a radially outer surface) and a first inner face 108A (e.g., a radially inner surface). In many embodiments, the first outer composite material 104A may be bonded to the first outer face 106A of the first tubular core 102A. The first inner face 108A may define a first passageway 110A (such as a fluid passageway), through which fluids, cables, or other components may extend. The first composite tube 100A may extend from a forward end 101A to an aft end 103A. The first tubular core 102A may extend (e.g., axially) between a first end 107A at the forward end 101A of the first composite tube 100A and a second end 109A at the aft end 103A of the first composite tube 100A. Further, in some embodiments, the first outer composite material 104A may extend (e.g., axially) between a first end 111A at the forward end 101A of the first composite tube 100A and a second end 113A at the aft end 103A of the first composite tube 100A.

The composite tube assembly 200 may further include a second composite tube 100B having a second tubular core 102B and a second outer composite material 104B. The second tubular core 102B may define a second outer face 106B (e.g., a radially outer surface) and a second inner face 108B (e.g., a radially inner surface). In many embodiments, the second outer composite material 104B may be bonded to the second outer face 106B of the second tubular core 102B. The second inner face 108B may define a second passageway 110B (such as a fluid passageway), through which fluids, cables, or other components may extend. The second composite tube 100B may extend from a forward end 101B to an aft end 103B. The second tubular core 102B may extend (e.g., axially) between a first end 107B at the forward end 101B of the second composite tube 100B and a second end 109B at the aft end 103B of the second composite tube 100B. Further, in some embodiments, the second outer composite material 104B may extend (e.g., axially) between a first end 111B at the forward end 101B of the second composite tube 100B and a second end 113B at the aft end 103B of the second composite tube 100B.

In exemplary embodiments, the first composite tube 100A may be coupled to the second composite tube 100B at a joint 202. In some embodiments, the aft end 103A of the first composite tube 100A may be coupled to the forward end 101B of the second composite tube 100B, such that the passageways 110A, 110B are aligned and fluid connected to one another. The first composite tube 100A and the second composite tube 100B may share a common axial centerline 150. Although it will be understood that this need not be the case.

Referring specifically to the embodiment shown in FIGS. 3 and 4, FIG. 3 illustrates a partially exploded view of the composite tube assembly 200, and FIG. 4 illustrates a fully assembled view of the composite tube assembly 200, in accordance with embodiments of the present disclosure. As shown, the second composite tube 100B may be coupled to the first composite tube via one or more couplers 204. The one or more couplers 204 may be coupled to an exterior surface (e.g., a radially outer surface) of the outer composite materials 104A, 104B at the joint 202. Particularly, the one or more couplers 204 may be centered on the joint 202, such that an equal portion of the coupler 204 is attached to both the first outer composite materials 104A and the second outer composite materials 104B. Although it will be understood that this need not be the case. The one or more couplers 204 may extend axially between a first end 208 coupled to the first outer composite material 104A and a second end 210 coupled to the second outer composite material 104B. Additionally, the one or more couplers 204 may include a first portion 212 coupled to the first outer composite material 104A and extending between the first end 208 and the joint 202 and a second portion 215 coupled to the second outer composite material 104B and extending between the joint 202 and the second end 210.

In a non-limiting example, the one or more couplers 204 may include a composite ply 206, which may be formed of the same material as the outer composite materials 104A, 104B. That is, the composite ply 206 may be formed of any composite material such as a ceramic matrix composite ply. In some embodiments, the one or more couplers 204 may be a single coupler 204 that annularly surrounds the outer composite materials 104A, 104B at the joint 202. In other embodiments, the one or more couplers 204 may be a plurality of couplers 204 circumferentially spaced apart from one another and each coupled to the outer composite materials 104A, 104B at the joint 202. The composite ply 206 may be processed to couple the outer composite materials 104A, 104B, such as by curing, bonding, heat treatment, or combinations thereof. The composite ply 206 adds thickness to the composite tube assembly 200, which may improve toughness and reduce deformation or cracking.

Referring specifically to the embodiment shown in FIGS. 5 and 6, FIG. 5 illustrates a partially exploded view of a composite tube assembly 300, and FIG. 6 illustrates a fully assembled view of the composite tube assembly 300, in accordance with embodiments of the present disclosure. As shown, the second composite tube 100B may be coupled to the first composite tube via one or more couplers 302. The one or more couplers 302 may be coupled to an exterior surface (e.g., a radially outer surface) of the outer composite materials 104A, 104B and at an axial surface of the outer composite materials 104A, 104B to form a joint 304. In some embodiments, the one or more couplers 302 may be a single coupler 302 that annularly surrounds the outer composite materials 104A, 104B. In other embodiments, the one or more couplers 302 may be a plurality of couplers 302 circumferentially spaced apart from one another and each coupled to the outer composite materials 104A, 104B.

As shown, the one or more couplers 302 may include a composite coupler 306 having a core 308 and a composite portion 310 bonded to the core 308. The core 308 may also be unreinforced. By way of non-limiting example, the core 216 can be formed of the same material as the tubular cores 102A, 102B (which may include silicon, silicon carbide, alumina, carbon, or aluminosilicates, or combinations thereof). The composite portion 310 may be formed of a similar material as the outer composite materials 104A, 104B (e.g., formed from a ceramic matrix composite). In exemplary embodiments, the core 308 of the composite coupler 306 includes a main portion 312 and a tab 314 extends (e.g., extends radially inward) from the main portion 312. In such embodiments, the composite portion 310 may be coupled to the main portion 312 of the core 308 (e.g., a radially outer surface of the main portion 312).

In many embodiments, the tab 314 may be positioned between the aft end 103A of the first composite tube 100A the forward end 101B of the second composite tube 100B. For example, the tab 314 may be positioned between, and contact, the second end 109A of the first tubular core 102A and the first end 107B of the second tubular core 102B. Similarly, the tab 314 may be positioned between, and contact, the second end 113A of the first outer composite material 104A and the first end 111B of the second outer composite material 104B.

Referring now to the embodiment shown in FIGS. 7 and 8, FIG. 7 illustrates a partially exploded view of a composite tube assembly 400, and FIG. 8 illustrates a joined view of the composite tube assembly 400, in accordance with embodiments of the present disclosure. As shown, a first composite tube 401A with a first tubular core 402A may include a first main portion 414A and a first flange 416A extending away from the first main portion 414A. For example, the first flange 416A may extend radially outwardly from the first main portion 414A to a terminal end. Similarly, a second composite tube 401B with a second tubular core 402B may include a second main portion 414B and a second flange 416B extending away from the second main portion 414B. For example, the second flange 416B may extend radially outwardly from the second main portion 414B to a terminal end.

A first outer composite material 404A may be bonded to both the first main portion 414A and the first flange 416A. The first flange 416A may define a forward face 420A and an aft face 422A. The first outer composite material 404A may include a first portion coupled to first outer surface 406A of first main portion 414A and a second portion coupled to the forward face 420A of the first flange 416A. Likewise, the second outer composite material 404B may be bonded to both the second main portion 414B and the second flange 416B. The second flange 416B may define a forward face 420B and an aft face 422B. The second outer composite material 404B may include a first portion coupled to second outer surface 406B of second main portion 414B and a second portion coupled to the aft face 422B of the second flange 416B.

In exemplary embodiments, the first flange 416A may be coupled to the second flange 416B. By way of non-limiting example, the first composite tube 401A and the second composite tube 401B may each define an aperture 426A, 426B (as indicated by the dashed lines in FIGS. 7 and 8) through the outer composite material 404A, 404B and the flanges 416A, 416B. In such embodiments, a fastener may be inserted through the apertures 426A, 426B to couple the flanges 416A, 416B together to form a joint 428. By way of non-limiting examples, a bolt or pin can be inserted and retained therein. The apertures 426A, 426B may be generally axially oriented and disposed radially between the main portion 414A, 414B and a terminal end of the flanges 416A, 416B. The apertures 426A, 426B may be circumferentially spaced about the flanges 416A, 416B such that, when fasteners are inserted into the apertures 426A, 426B, the flanges 416A, 416B are secured to each other in a substantially even manner. The aft face 422A of the first flange 416A may contact the forward face 420B of the second flange 416B. By integrating the flanges 416A, 416B into composite cores 402A, 402B, the flanges 416A, 416B allow for easier integration of the composite tubes 401A, 401B with other components.

Referring now to the embodiment shown in FIGS. 9 and 10, FIG. 9 illustrates a partially exploded view of the composite tube assembly 500, and FIG. 10 illustrates an assembled view of the composite tube assembly 500, in accordance with embodiments of the present disclosure. As shown, in some embodiments, a first composite tube 501A with a first tubular core 502A includes a first main portion 552A and a first tapering portion 554A that extends from the first main portion 552A. Particularly, the first main portion 552A may extend axially from a first end 507A to the first tapering portion 554A. The first tapering portion 554A may extend axially from the first main portion 552A to a first aft end 509A. In such embodiments, a first outer surface 506A of the first tubular core 502A converges radially inward (e.g., towards a generally axially-oriented first inner surface 508A) as the first tapering portion 554A extends from the first main portion 552A to an aft end 503A of the first composite tube 501A.

Likewise, a second composite tube 501B with a second tubular core 502B may include a second main portion 552B and a second tapering portion 554B that extends from the second main portion 552B. Particularly, the second tapering portion 554B may extend axially from a first end 507B to the second main portion 552B. A second inner surface 508B of the second tubular core 502B may diverge radially outwardly (e.g., towards a generally axially-oriented second outer surface 506B) as the second tapering portion 554B extends from a forward end 505B of the second composite tube 501B to the second main portion 552B.

In exemplary embodiments, as shown in FIG. 10, the first tapering portion 554A may extend into the second tapering portion 554B such that the first outer composite material 504A is positioned between (e.g., radially between) the outer surface 506A of the first tubular core 502A and the inner surface 508B of the second tubular core 502B. In some embodiments, the first outer composite material 504A may be bonded (e.g., with adhesive) to both the outer surface 506A of the first tubular core 502A and the inner surface 508B of the second tubular core 502B.

As a non-limiting example, an adhesive may at least partially bond the first composite tube 501A to the second composite tube 501B. In such embodiments, the adhesive may be one of silicon, silicon alloys, matrix precursors, seal glasses, or combinations thereof. The adhesive may be disposed between the first composite tube 501A to the second composite tube 501B.

As another non-limiting example, not shown in the FIGS., the first composite tube 501A may include threads that mate with a tapped region of the second tubular core 502B. In such a form, the threads and tapped region may form a fluid tight connection that secures the first composite tube 501A to the second composite tube 501B. That is, the threads and the tapped region may be sized such that, when the threads engage the tapped region, a fluid may flow through the passageways 510A, 510B without leakage.

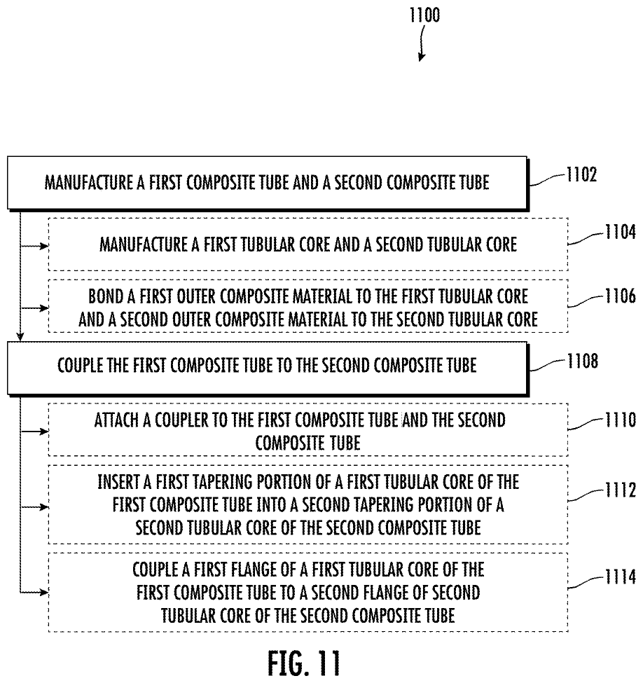

Referring now to FIG. 11, a flow diagram of one embodiment of a method 1100 of manufacturing a composite tube assembly is illustrated in accordance with embodiments of the present subject matter. In general, the method 1100 will be described herein with reference to the composite tube 100 and the composite tube assemblies 200, 300, 400, 500 described above with reference to FIGS. 1 through 10. However, it will be appreciated by those of ordinary skill in the art that the disclosed method 1100 may generally be utilized with any suitable composite tube assembly. In addition, although FIG. 11 depicts steps performed in a particular order for purposes of illustration and discussion, the methods discussed herein are not limited to any particular order or arrangement unless otherwise specified in the claims. One skilled in the art, using the disclosures provided herein, will appreciate that various steps of the methods disclosed herein can be omitted, rearranged, combined, and/or adapted in various ways without deviating from the scope of the present disclosure. The dashed boxes may indicate optional steps of the method 1100.

As shown, the method 1100 may include at (1102) manufacturing a first composite tube and a second composite tube. Manufacturing at (1102) may further include at (1104) manufacturing a first tubular core and a second tubular core. This may further include additively manufacturing the first tubular core or the second tubular core. For example, all or portions of the first tubular core or the second tubular core may be additively manufactured, such as via a binder jet or similar process to produce an additively manufactured core. Particularly, core shown in FIG. 1 may be additively manufactured to produce the plurality of hollow cells. In this way, the plurality of lattice walls may be additively manufactured by building some or all of the plurality of lattice walls in a layer-by-layer manner, such as by using a powder feedstock material.

In such embodiments, additive manufacturing the plurality of lattice walls can result in a residual amount of loose unconsolidated powder feedstock in the hollow interior of each of the plurality of hollow cells. Thus, in some embodiments, the method may further comprise removing the powder feedstock from at least one of the plurality of hollows cells. For example, the powder feedstock may be poured or vacuumed out of an opening of the hollow cell. Removal of the powder feedstock can further allow for the unused powder feedstock to be recycled and used to make cores for additional composite tubes or other parts of the composite panel.

While additive manufacturing is disclosed as an exemplary method for manufacturing the core, it should be appreciated that other ceramic processing techniques may also be utilized within the scope of this disclosure such as, for example, extrusion processing. Depending on the materials used, the manufacturing process, or other manufacturing variables, the core may be ready for use in the composite panel, or may require one or more further intermediate processing steps. For example, in some embodiments, the core may be in a green state after additive manufacturing. Thus, in such embodiments, the method may further comprise curing the core to remove moisture or sintering the core.

In some embodiments, manufacturing at (1102) may further include at (1106) bonding a first outer composite material to the first tubular core and a second outer composite material to the second tubular core. Bonding may include any suitable process to mechanically integrate the outer composite materials with the tubular cores. For example, bonding at (1106) may include adhesive bonding. In some embodiments, bonding at (1106) may include one or more manufacturing steps utilized in manufacturing ceramic matrix composites, such as infiltration of the ceramic material or curing.

In exemplary embodiments, the method 1100 may further include at (1108) coupling the first composite tube to the second composite tube. In some embodiments, joining at (1108) may further include at (1110) attaching a coupler to the first composite tube and the second composite tube. The coupler may be one of a composite ply (FIGS. 3 and 4) or a composite coupler (FIGS. 5 and 6). In other embodiments, joining at (1108) may further include at (1112) inserting a first tapering portion of a first tubular core of the first composite tube into a second tapering portion of a second tubular core of the second composite tube. The first tapering portion may be bonded to the second tapering portion in many embodiments. In yet still further embodiments, joining at (1108) may include at (1114) coupling a first flange of a first tubular core of the first composite tube to a second flange of second tubular core of the second composite tube. This may include aligning the flanges and inserting a bolt through apertures defined in both flanges. It will be appreciated that any or all of these components that join the first composite tube and the second composite tube may be used in any combination for a suitable connection.

The composite tube assembly 200, 300, 400, 500 as disclosed and described herein may be used in a variety of industrial machines, including but not limited to one or more components of turbomachines. Moreover, the composite tube assembly 200, 300, 400, 500 disclosed and described herein can provide a more cost-effective, lighter, and potentially stronger alternative to solid composite structures. However, the composite tubes disclosed and described herein further provides enhanced bonding between the core and the composite materials.

This written description uses examples to disclose the present disclosure, including the best mode, and also to enable any person skilled in the art to practice the disclosure, including making and using any devices or systems and performing any incorporated methods. The patentable scope of the disclosure is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

Further aspects are provided by the subject matter of the following clauses:

A composite tube assembly including a first composite tube having a first tubular core and a first outer composite material, the first outer composite material bonded to a first face of the first tubular core, and a second composite tube having a second tubular core and a second outer composite material, the second outer composite material bonded to a second face of the second tubular core, wherein the second composite tube is coupled to the first composite tube.

The composite tube assembly of any of the preceding clauses, wherein the second composite tube is coupled to the first composite tube via one or more couplers.

The composite tube assembly of any of the preceding clauses, wherein the one or more couplers includes at least one composite ply coupled to the first outer composite material and the second outer composite material.

The composite tube assembly of any of the preceding clauses, wherein the one or more couplers include a composite coupler having an unreinforced ceramic coupler core and a composite material bonded to the unreinforced ceramic coupler core.

The composite tube assembly of any of the preceding clauses, wherein the unreinforced ceramic coupler core includes a main portion and a tab extending from the main portion, and wherein the composite material is coupled to the main portion of the unreinforced ceramic coupler core.

The composite tube assembly of any of the preceding clauses, wherein, when coupled, the tab is positioned between the first composite tube and the second composite tube.

The composite tube assembly of any of the preceding clauses, wherein the first tubular core includes a first main portion and a first flange extending radially from the first main portion, and wherein the second tubular core includes a second main portion and a second flange extending radially from the second main portion.

The composite tube assembly of any of the preceding clauses, wherein the first outer composite material is bonded to both the first main portion and the first flange, and wherein the second outer composite material is bonded to both the second main portion and the second flange.

The composite tube assembly of any of the preceding clauses, wherein the first flange is coupled to the second flange with a fastener.

The composite tube assembly of any of the preceding clauses, wherein the first tubular core includes a main portion having a first tapering portion and wherein the second tubular core includes a second tapering portion forming a socket.

The composite tube assembly of any of the preceding clauses, wherein, when coupled, the first tapering portion extends into the second tapering portion such that the first outer composite material is positioned between an outer surface of the first tubular core and an inner surface of the second tubular core.

The composite tube assembly of any of the preceding clauses, further including an adhesive, the adhesive configured to at least partially bond the first composite tube to the second composite tube, and wherein the adhesive is one of silicon, silicon alloys, matrix precursors, seal glasses, or combinations thereof.

The composite tube assembly of any of the preceding clauses, wherein at least one of the first outer composite material or the second outer composite material include a ceramic matrix composite.

The composite tube assembly of any of the preceding clauses, wherein at least one of the first tubular core or the second tubular core includes silicon, silicon carbide, alumina, carbon, aluminosilicates, or combinations thereof.

The composite tube assembly of any of the preceding clauses, wherein at least one of the first tubular core or the second tubular core is an additively manufactured core.

A method of manufacturing the composite tube assembly of any of the preceding clauses, the method including manufacturing a first composite tube and a second composite tube and coupling the first composite tube to the second composite tube.

The method of any of the preceding clauses, wherein manufacturing the first composite tube and the second composite tube includes manufacturing at least one of a first tubular core or a second tubular core and bonding an outer composite material to the first tubular core or the second tubular core.

The method of any of the preceding clauses, wherein coupling the first composite tube to the second composite tube includes attaching a coupler to the first composite tube and the second composite tube, the coupler including one of a composite ply or a composite coupler.

The method of any of the preceding clauses, wherein coupling the first composite tube to the second composite tube includes inserting a first tapering portion of a first tubular core of the first composite tube into a second tapering portion of a second tubular core of the second composite tube.

The method of any of the preceding clauses, wherein joining the first composite tube to the second composite tube includes coupling a first flange of a first tubular core of the first composite tube to a second flange of second tubular core of the second composite tube.

We claim:

1. A composite tube assembly comprising:
a first composite tube having a first tubular core and a first outer composite material, the first outer composite material bonded to a first face of the first tubular core; and
a second composite tube having a second tubular core and a second outer composite material, the second outer composite material bonded to a second face of the second tubular core, wherein the second composite tube is coupled to the first composite tube.

2. The composite tube assembly of claim 1, wherein the second composite tube is coupled to the first composite tube via one or more couplers.

3. The composite tube assembly of claim 2, wherein the one or more couplers includes at least one composite ply coupled to the first outer composite material and the second outer composite material.

4. The composite tube assembly of claim 2, wherein the one or more couplers include a composite coupler having an unreinforced ceramic coupler core and a composite material bonded to the unreinforced ceramic coupler core.

5. The composite tube assembly of claim 4, wherein the unreinforced ceramic coupler core includes a main portion and a tab extending from the main portion, and wherein the composite material is coupled to the main portion of the unreinforced ceramic coupler core.

6. The composite tube assembly of claim 5, wherein, when coupled, the tab is positioned between the first composite tube and the second composite tube.

7. The composite tube assembly of claim 1, wherein the first tubular core comprises a first main portion and a first flange extending radially from the first main portion, and wherein the second tubular core comprises a second main portion and a second flange extending radially from the second main portion.

8. The composite tube assembly of claim 7, wherein the first outer composite material is bonded to both the first main portion and the first flange, and wherein the second outer composite material is bonded to both the second main portion and the second flange.

9. The composite tube assembly of claim 7, wherein the first flange is coupled to the second flange with a fastener.

10. The composite tube assembly of claim 1, wherein the first tubular core includes a main portion having a first tapering portion and wherein the second tubular core includes a second tapering portion forming a socket.

11. The composite tube assembly of claim 10, wherein, when coupled, the first tapering portion extends into the second tapering portion such that the first outer composite material is positioned between an outer surface of the first tubular core and an inner surface of the second tubular core.

12. The composite tube assembly of claim 1, further comprising an adhesive, the adhesive configured to at least partially bond the first composite tube to the second composite tube, and wherein the adhesive is one of silicon, silicon alloys, matrix precursors, seal glasses, or combinations thereof.

13. The composite tube assembly of claim 1, wherein at least one of the first outer composite material or the second outer composite material comprise a ceramic matrix composite.

14. The composite tube assembly of claim 1, wherein at least one of the first tubular core or the second tubular core comprises silicon, silicon carbide, alumina, carbon, aluminosilicates, or combinations thereof.

15. The composite tube assembly of claim 1, wherein at least one of the first tubular core or the second tubular core is an additively manufactured core.

16. A method of manufacturing the composite tube assembly of claim 1, the method comprising:
manufacturing a first composite tube and a second composite tube; and
coupling the first composite tube to the second composite tube.

17. The method of claim 16, wherein manufacturing the first composite tube and the second composite tube comprises:
manufacturing at least one of a first tubular core or a second tubular core; and
bonding an outer composite material to the first tubular core or the second tubular core.

18. The method of claim 16, wherein coupling the first composite tube to the second composite tube comprises:
attaching a coupler to the first composite tube and the second composite tube, the coupler comprising one of a composite ply or a composite coupler.

19. The method of claim 16, wherein coupling the first composite tube to the second composite tube comprises:
inserting a first tapering portion of a first tubular core of the first composite tube into a second tapering portion of a second tubular core of the second composite tube.

20. The method of claim 16, wherein joining the first composite tube to the second composite tube comprises:
coupling a first flange of a first tubular core of the first composite tube to a second flange of second tubular core of the second composite tube.
